(19) United States
(12) Patent Application Publication
(10) Pub. No.: US 2005/0102886 A1
(43) Pub. Date: May 19, 2005

(54) Sport fishing protection system

(76) Inventor: Thomas Eugene Ball SR., Bumpass, VA (US)

Correspondence Address: Thomas Eugene Ball, Sr., 2845 Bethany Church Road, Bumpass, VA, 23024, US

(21) Appl. No.: 10/636,678

(22) Filed: Aug. 7, 2003

(51) Int. Cl. A01K 97/20

(52) U.S. Cl. 43/55

(57) ABSTRACT

A mesh bag made of neoprylene or some other plastic, non-metallic mesh material, roughly rectangular in shape with three (3) zippered sides for protection and identification of sport fish. After the fish are caught, they are placed in identifiable mesh bags and placed in a live well. The bags serve to protect the fish and make them easily identifiable.

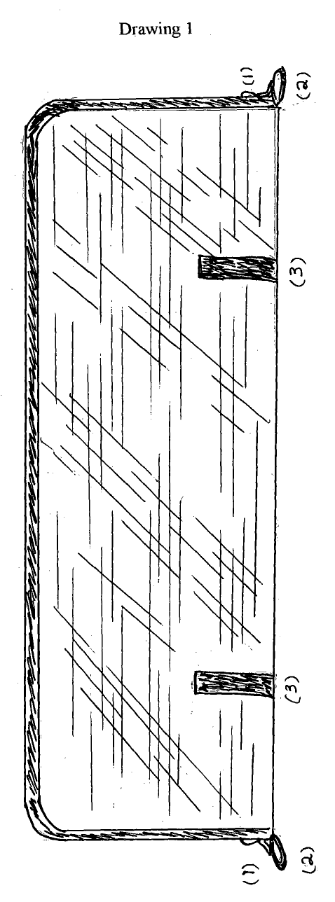

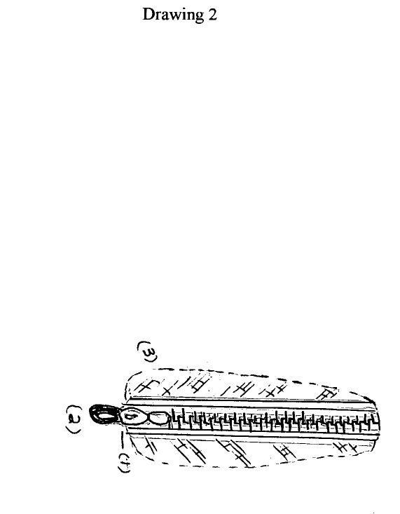

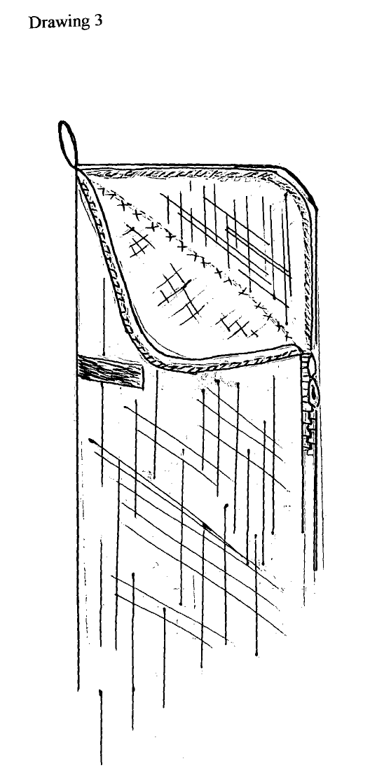

### SUMMARY

This system is designed to separate, protect and weigh sport and game fish that are held in a live well during sport fishing tournaments or other fishing activity.

The system is constructed of a rubber or neoprylene or other non-metallic mesh, especially premium netted polyefin, cut to size in a rectangular shape when fully closed, zippered on three (3) sides so that when it is un-zippered one can insert a fish into the bag or remove it from either end. The raw edges of the mesh are bound in cloth with a zipper sewn into the binding.

Boning, constructed of plastic or other suitable material, stitched into the bottom of the bag and centered there, keeps the bag open around fins and gills, allowing fresh water to move freely around the fish and allowing the fish room to move. The mesh has a smooth surface which will not irritate the fish, or remove scales or fins. This material is not harmful to the slime layer of fish.

The system has a loop sewn into the binding at the bottom fold for hanging both fish and the bag from a scale so that they can be weighed together since the bag weight is known. This system allows for the fish to remain untouched after placement in the bag, and during weighing and release.

The bags are color coded for easy identification, and the mesh construction allows the fish to remain suspended in a live well without suffering damages from other objects and fish in the well.

This system also protects the fish from losing its natural slime layer via contact with human hands. The fish are more comfortable in the live well in the mesh bag, and are easily retrieved from the well. This system removes any need for gill penetration for purposes of culling and identifying fish.

### BACKGROUND

### FIELD OF THE INVENTION

This invention belongs in the field associated with fishing, for holding and transporting fish that have been caught. This invention is also related to animal husbandry and the transportation and care of fish after they are caught.

### PRIOR ART

The prior art demonstrates receptacles for holding many fish, either in a mesh-like enclosure in a larger body of water or in a self-enclosed system for transport. There is no prior art that allows for a single fish to be held individually in a mesh system in a larger body of water such as a live well.

### DRAWINGS

Drawing 1. Side perspective

Drawing 2. Lateral View

Drawing 3. Side Perspective

### DESCRIPTION

DRAWING 1 shows the zipper pull on the ends (1) which enables the bag to be opened and closed from either end. The hanging loop (2) allows the system to be weighed when a fish is contained. Two boning pieces shown sewn across the bottom of the bag (3) aids in holding the bag open so the fish has room to move its' fins and gills, remaining upright and breathing properly.

DRAWING 2 shows the zipper pull in detail (1) and the hanging/weighing loop (2). Also note how the boning holds the bag open around the fish when the bag is closed so that the fish will have room for gill and fin movement.

DRAWING 3 shows one end of the bag open for insertion and retrieval of fish.

### OPERATION

In operation, a game or sport fish is caught by the angler, and is inserted into the mesh bag via the zippered opening. The bag with fish inside may then be weighed, released, or placed in alive well. The bag serves to protect the fish from the live well environment and the damage caused by human contact, while allowing the fish to be easily identified and retrieved.

1. The Main purpose of this Protection Device is for the well being and safety of the fish as it is being held throughout the day in a Tournament Environment, or otherwise being held in a live well.

2. The fish is kept in a state of ease inside the Protection Device as it is being transported in a live well. The frequent opening and closing of the live well lid does not cause the fish any trauma or excitement.

3. When the angler reaches in to capture the fish for culling or weighing, the fish is not touch by the hand, only the Protection Device is touched. There is no fright to the fish as it doesn't have to be chased around the enclosure to be captured.

4. The structure of the Protection Device is made to allow the fish enough room to stay upright and afloat.

5. The material that the Protection Device is constructed from, allows fresh aerated water to flow through to the fish.

6. The material that the Protection Device is constructed from, allows the fish to be handled without removing protective slime from the fish's body

7. The Protection Device is equipped with a hanging loop to enable the fish to be weighed without being stuck through the mouth with a hook on a scale.

8. The Protection Device is equipped with a double opening zipper to enable the fish to be inserted and removed with the least amount of damage to the fish.

9. The zippers on the set of The Protection Device are to be color coded allowing culling at a glance.

10. The Protection Device is so designed as to protect the fish from other fish in the live well, as well to do away with the culling devices that are used today that are inserted into the mouth of the fish. These devices can cause damage to the mouth they are inserted into and also to the other fish in the live well.
